(19) United States
(12) Patent Application Publication
(10) Pub. No.: US 2026/0256113 A1
(43) Pub. Date: Sep. 3, 2026

(54) FEEDING DEVICE

(71) Applicant: TOHOKU UNIVERSITY, Sendai-shi, Miyagi (JP)

(72) Inventors: Kazunori OHNO, Sendai-shi (JP); Shoichi NEZU, Sendai-shi (JP)

(21) Appl. No.: 18/867,236

(22) PCT Filed: May 24, 2023
(86) PCT No.: PCT/JP2023/019392

§ 371 Date: Nov. 19, 2024

(30) Foreign Application Priority Data
May 26, 2022 (JP) 2022-086095

(51) Int. Cl. A01K 5/02; A01K 15/02; A01K 27/00

(52) U.S. Cl. CPC A01K 5/02; A01K 15/02; A01K 27/002

(57) ABSTRACT

A feeding device includes an attachment part to be attached to an animal, a supplier provided on the attachment part and supplying a feed into a field of view of the animal that is in a standing posture and faces forward, and a controller for controlling the supplier, and the supplier is disposed on a back portion of the animal in a state of being provided on the attachment part.

### CROSS-REFERENCE TO RELATED APPLICATIONS

This application is the U.S. National Stage entry of International Application No. PCT/JP2023/019392, filed on May 24, 2023, which, in turn, claims priority to. Japanese Patent Application No. 2022-086095, filed on May 26, 2022, both of which are hereby incorporated herein by reference in their entireties for all purposes.

### TECHNICAL FIELD

The present invention relates to a feeding device.

### BACKGROUND ART

In the related art, a feeding device for supplying feed to an animal such as a dog is known (for example, see Patent Documents 1 and 2 and Non-Patent Document 1).

For example, the feeding device is installed in a room of a house. The feeding device is operated by wireless communication using a portable terminal or by a timer. While the dog owner is away from home, when the owner operates the portable terminal or the set time arrives, the feeding device supplies the feed. In addition, the feeding device can be used not only to feed the dog but also to encourage the dog to exercise or to train the dog's behavior.

A feeding device that can be attached to a collar or a harness worn by a dog is known as a device focusing on encouraging the dog to exercise or training the dog's behavior (for example, Patent Document 3).

### CITATION LIST

### Patent Literature

Patent Document 1: JP 2018-201490 A
Patent Document 2: JP 2001-112368 A
Patent Document 3: JP 2008-539701 T

### Non-Patent Literature

Non-Patent Document 1: Furbo, [Search on May 13, 2022], Internet <URL: https://furbo.com/jp>

### SUMMARY OF INVENTION

### Technical Problem

However, the dog may often be in a place in the house far from where the feeding device is installed. In this case, even if the feed is supplied by the feeding device, the dog cannot notice the feed.

In addition, even when the feed is supplied near the dog, if the feed is supplied at a position where the dog cannot be seen, it is difficult for the dog to notice the feed.

Additionally, when the feeding device is attached as in Patent Document 3, it is difficult to eject the feed so as to be within the viewing angle of the dog, and it is difficult to encourage the dog to exercise or to conduct the behavior training, as expected.

In particular, when the feeding device is attached to the collar or the chest strap of the harness as in Patent Document 3, the dog is fed at the feet or nearby, causing the dog to stay in place, which makes it difficult to train the dog, such as guiding the dog in a predetermined direction.

The present invention has been made in view of the above situations, and an object of the present invention is to provide a feeding device capable of guiding an animal in an expected direction while supplying feed to a position easily noticeable by the animal at a movement destination of the animal.

### Solution to Problem

To address the problems described above, the present invention suggests the following means.

(1) A first aspect of the present invention is a feeding device including: an attachment part configured to be attached to an animal; a supplier provided on the attachment part and configured to supply a feed into a field of view of the animal that is in a standing posture and faces forward; and a controller configured to control the supplier, wherein the supplier is disposed on a back portion of the animal in a state of being provided on the attachment part.

(2) A second aspect of the present invention may be the feeding device according to (1), wherein the supplier includes: a holder configured to hold the feed and deliver the feed based on control of the controller, a launcher configured to shoot the feed supplied from the holder, and a trajectory corrector configured to adjust an orientation of the feed to be shot so that the feed shot from the launcher is supplied into the field of view of the animal that is in the standing posture and faces forward.

(3) A third aspect of the present invention may be the feeding device according to (1) or (2), wherein the animal is a vertebrate, the attachment part includes a support member disposed on a back portion of the vertebrate, a pair of elastic members attached to an outer surface of the support member on the back portion side and being in contact with the back portion with a backbone of the vertebrate interposed therebetween, and an attaching/detaching part configured to detachably attach the support member to the back portion of the vertebrate, and each of the elastic members includes a first elastic piece disposed on a head portion side of the vertebrate and a second elastic piece disposed on a side opposite to the head portion with respect to the first elastic piece and thicker than the first elastic piece.

(4) A fourth aspect of the present invention may be the feeding device according to any one of (1) to (3), further including a sound generator configured to generate a sound when the feed is supplied by the supplier.

(5) A fifth aspect of the present invention may be the feeding device according to any one of (1) to (4), further including a wireless communicator configured to receive a signal by wireless communication and transmit the received signal to the controller, wherein the controller supplies the feed by the supplier when the signal is received.

### Advantageous Effects of Invention

According to the feeding device of the present invention, the feed can be supplied to a position easily noticeable by the animal at a movement destination of the animal, making it possible to guide the animal in an expected direction.

### BRIEF DESCRIPTION OF DRAWINGS

FIG. 1 is a side view of a dog to which a feeding device according to a first embodiment of the present invention is attached.

FIG. 2 is a bottom view of the feeding device attached to the dog.

FIG. 3 is a block diagram of the feeding device.

FIG. 4 is a front cross-sectional view of the feeding device attached to the dog.

FIG. 5 is a cross-sectional view taken along line A1-A1 in FIG. 4.

FIG. 6 is a bottom view when a support member and a sponge are unfolded.

FIG. 7 is a front view of the feeding device attached to the dog.

FIG. 8 is a plan view illustrating a field of view of the dog.

FIG. 9 is a perspective view of a supplier of the feeding device.

FIG. 10 is a side view schematically showing the supplier.

FIG. 11 is a perspective view of a holder in the supplier.

FIG. 12 is a perspective view of a holder in a feeding device according to a first modification of the first embodiment of the present invention.

FIG. 13 is a side view of a launcher in a feeding device according to a second modification of the first embodiment of the present invention.

FIG. 14 is a side view of a launcher in a feeding device according to a third modification of the first embodiment of the present invention.

FIG. 15 is a side view of a launcher in a feeding device according to a fourth modification of the first embodiment of the present invention.

FIG. 16 is a photograph showing a side of a feed used in a test.

FIG. 17 is a photograph showing a side of an example of a roller used in the test.

FIG. 18 is a photograph showing a side of another example of the roller used in the test.

FIG. 19 is a photograph showing a side of another example of the roller used in the test.

FIG. 20 is a perspective view of a supplier of a feeding device according to a second embodiment of the present invention.

FIG. 21 is an exploded perspective view of main parts of the supplier.

### DESCRIPTION OF EMBODIMENT

### First Embodiment

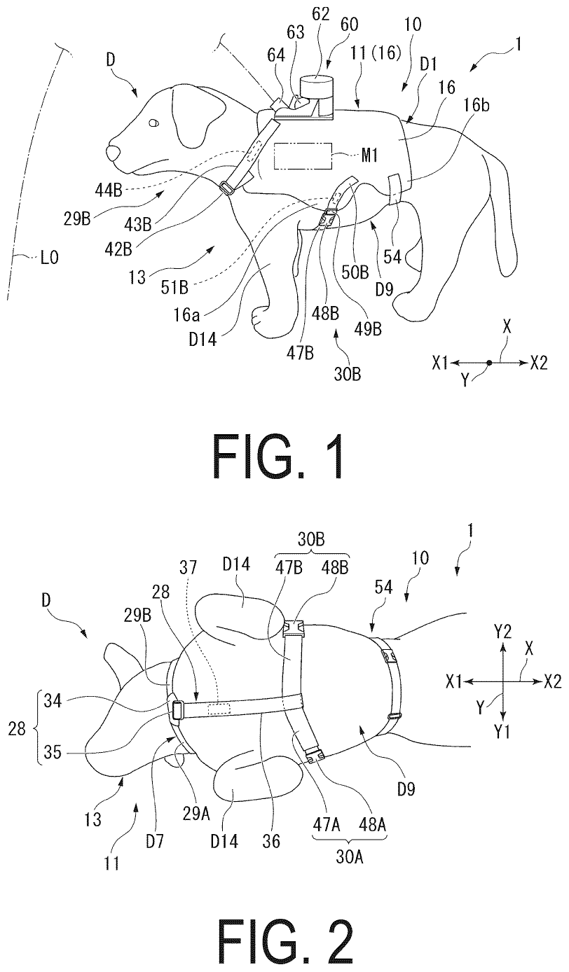

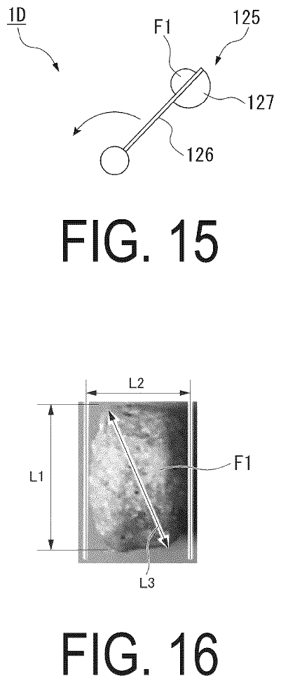

A feeding device according to a first embodiment of the present invention will be described below with reference to FIGS. 1 to 19. Hereinafter, a case where an animal (excluding a human being) to which the feeding device is attached is a dog (vertebrate) will be described as an example.

As shown in FIGS. 1 and 2, a feeding device 1 of the present embodiment is used by being attached to a dog D.

It is preferable that the dog D is either a service dog that has undergone a certain training or a general household dog (pet). Examples of the dog D include a Golden Retriever, a German Shephard dog, and the like in the case of a large dog weighing around 30 kg. In the case of a medium-sized dog weighing around 15 kg, examples include a Britani Spaniel and the like. In the case of a small dog weighing around 8 kg, examples include a Jack Russell Terrier and the like

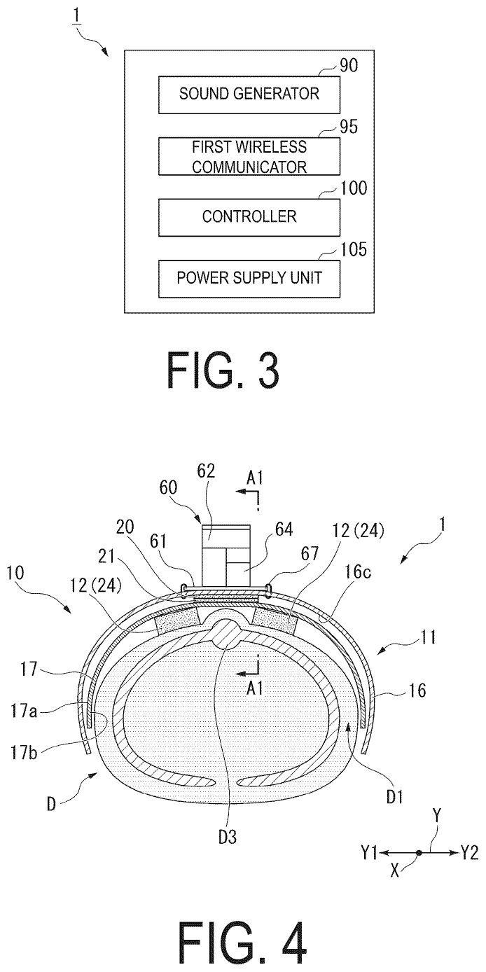

The feeding device 1 is a device for providing feed to the dog D. In the present embodiment, it is assumed that feed is provided to the dog D as a reward. As shown in FIGS. 1 and 3, the feeding device 1 includes an attachment part 10, a supplier 60, a sound generator 90, a first wireless communicator (wireless communicator) 95, a controller 100, and a power supply unit 105.

Hereinafter, the configuration of the feeding device 1 will be described using a front side X1, a rear side X2, a right side Y1, and a left side Y2 (see FIG. 2) with respect to the dog D to which the feeding device 1 is attached. A direction including the front side X1 and the rear side X2 is a front-rear direction X, and a direction including the right side Y1 and the left side Y2 is a left-right direction Y.

It is assumed that a posture of the dog D to which the feeding device 1 is attached is a standing posture and the face of the dog D faces the front side X1 (hereinafter, referred to as a standard posture). The term “standing posture” as used herein refers to a posture when an animal such as the dog D stands on a support surface or moves by walking or running on the support surface with the chest spaced upward from the support surface by all legs. The support surface may be the ground, a floor of a house, or the like.

As shown in FIG. 4, the configuration of the attachment part 10 is not limited as long as it can be attached to the dog D. For example, the attachment part 10 includes a support member 11, a pair of sponges (elastic members) 12, and an attaching/detaching part 13 (see FIG. 1).

The support member 11 is disposed on a back portion D1 of the dog D. The support member 11 includes a base material 16 and a support plate 17.

The base material 16 is for example, a cloth and is formed in a sheet shape. As the base material 16, a relatively strong fabric such as a fabric with an adhesive core on a cloth, a fabric laminated to a cloth, or a fabric with a vinyl coating on a cloth, may be used. In order to improve the air permeability of the base material 16, the base material 16 may be provided with a mesh layer.

The base material 16 has a rectangular shape when the base material 16 is unfolded and flattened and is seen in a thickness direction of the base material 16. As shown in FIG. 1, flaps 16a and 16b are formed on sides of the base material 16 that become the right side Y1 and the left side Y2 of the dog D when the base material 16 is attached to the dog D. The flap 16a is formed on the front side X1 relative to the flap 16b.

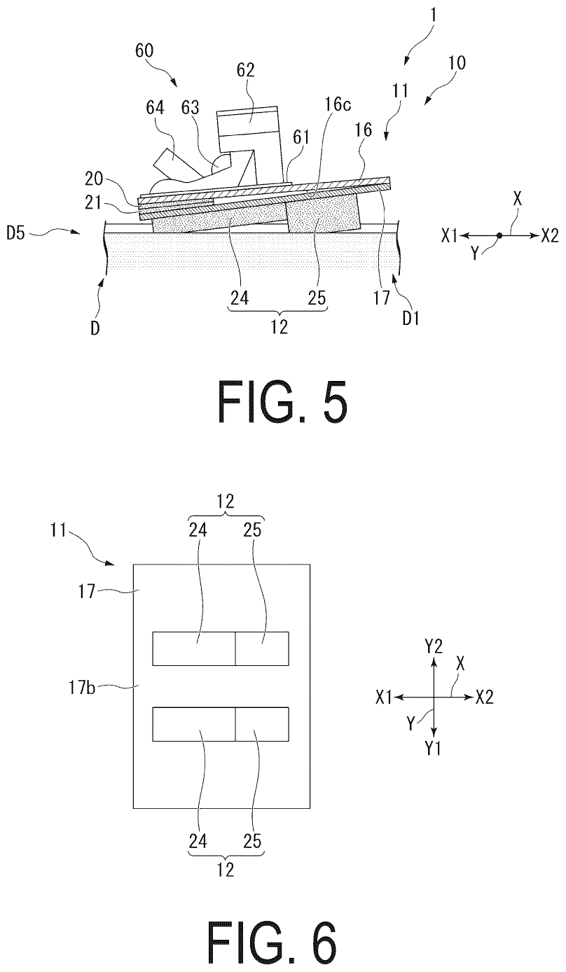

As shown in FIGS. 4 and 5, a first hook-and-loop fastener 20 is fixed to a central portion in the left-right direction Y of a first main surface 16c that is a surface of the base material 16 facing the dog D side. The first hook-and-loop fastener 20 is fixed to an end portion on the front side X1 of the base material 16 by an adhesive, a sewing thread, or the like.

The support plate 17 is formed of a light, thin, and flexible plate material. Specifically, the support plate 17 is formed of a plate material made of a resin such as polypropylene, vinyl chloride, polycarbonate, or nylon. The support plate 17 has a rectangular shape when the support plate 17 is unfolded and flattened and is seen in a thickness direction of the support plate 17. The support plate 17 can be curved along the back portion D1 of the dog D by applying an external force. Note that a carbon material obtained by plain-weaving fibrous carbon may be used for the support plate 17.

The support plate 17 is disposed closer to the back portion D1 side of the dog D than the base material 16 in a state of being curved along the back portion D1.

A second hook-and-loop fastener 21 is fixed to a central portion in the left-right direction Y of an outer surface 17a of the support plate 17 facing the base material 16. Note that the first hook-and-loop fastener 20 and the second hook-and-loop fastener 21 constitute a hook-and-loop fastener.

The second hook-and-loop fastener 21 is fixed to an end portion on the front side X1 of the support plate 17 by an adhesive or the like. The second hook-and-loop fastener 21 is detachably attached to the first hook-and-loop fastener 20.

As such, the end portion on the front side X1 of the base material 16 and the end portion on the front side X1 of the support plate 17 can be attached to and detached from each other by the hook-and-loop fasteners 20 and 21 at the central portions in the left-right direction Y of the base material 16 and the support plate 17.

Note that an end portion on the rear side X2 of the base material 16 and an end portion on the rear side X2 of the support plate 17 are fixed to each other by a fixing member (not shown) such as a sewing thread.

As shown in FIG. 4, the pair of sponges 12 are attached to an outer surface 17b of the support plate 17 on an opposite side to the outer surface 17a (an outer surface of the support member 11 on the back portion D1 side of the dog D). The pair of sponges 12 are in direct contact with the back portion D1 of the dog D with the backbone (vertebrae) D3 of the dog D sandwiched therebetween. A distance between the pair of sponges 12 is preferably about a diameter of the backbone D3 of the dog D to which the feeding device 1 is attached.

As shown in FIGS. 5 and 6, each sponge 12 has a first elastic piece 24 and a second elastic piece 25. The elastic pieces 24 and 25 each have a rectangular parallelepiped shape. The elastic pieces 24 and 25 each extend in the front-rear direction X.

The elastic pieces 24 and 25 are formed of a known rubber sponge or the like.

The first elastic piece 24 is disposed on a head portion D5 side of the dog D on the support plate 17.

A thickness of the second elastic piece 25 is thicker than a thickness of the first elastic piece 24. The thickness of the first elastic piece 24 here refers to a length of the first elastic piece 24 in a thickness direction of a portion of the support member 11 to which the first elastic piece 24 is attached.

The second elastic piece 25 is disposed on a side opposite to the head portion D5 of the dog D with respect to the first elastic piece 24. The elastic pieces 24 and 25 are disposed side by side in the front-rear direction X. For example, the elastic pieces 24 and 25 are attached to the support plate 17 by a sewing thread, an adhesive, or the like.

Compressive stresses of the elastic pieces 24 and 25 at 25% strain, based on the regulation of foamed plastic-polyethylene-test method (JIS K 6767:1999), are preferably 1 kPa (kilopascal) or higher and 50 kPa or less, and more preferably 2 kPa or higher and 10 kPa or less. The above-described compressive stresses may be 130 kPa depending on internal structures such as lengths and thicknesses of the elastic pieces 24 and 25 in the left-right direction Y and composition of the air bubbles of the elastic pieces 24 and 25.

The thicknesses of the elastic pieces 24 and 25 are preferably changed in accordance with the compressive stress of the elastic pieces 24 and 25.

The attaching/detaching part 13 is not limited as long as it detachably attaches the support member 11 to the back portion D1 of the dog D. As shown in FIGS. 1 and 2, for example, the attaching/detaching part 13 includes a coupler 28, first length adjustment mechanisms 29A and 30A, and second length adjustment mechanisms 29B and 30B.

In the present embodiment, the first length adjustment mechanism 29A and the second length adjustment mechanism 29B have the same configuration. For this reason, the configuration of the first length adjustment mechanism 29A is indicated by adding a capital letter “A” to a number. The configuration of the second length adjustment mechanism 29B corresponding to that of the first length adjustment mechanism 29A is indicated by adding a capital letter “B” to the same number as that of the first length adjustment mechanism 29A. Thus, redundant description will be omitted.

For example, a first belt piece 29A of the first length adjustment mechanism 40A and a first belt piece 29B of the second length adjustment mechanism 40B have the same configuration.

The same applies to the first length adjustment mechanism 30A, the second length adjustment mechanism 30B, and the like.

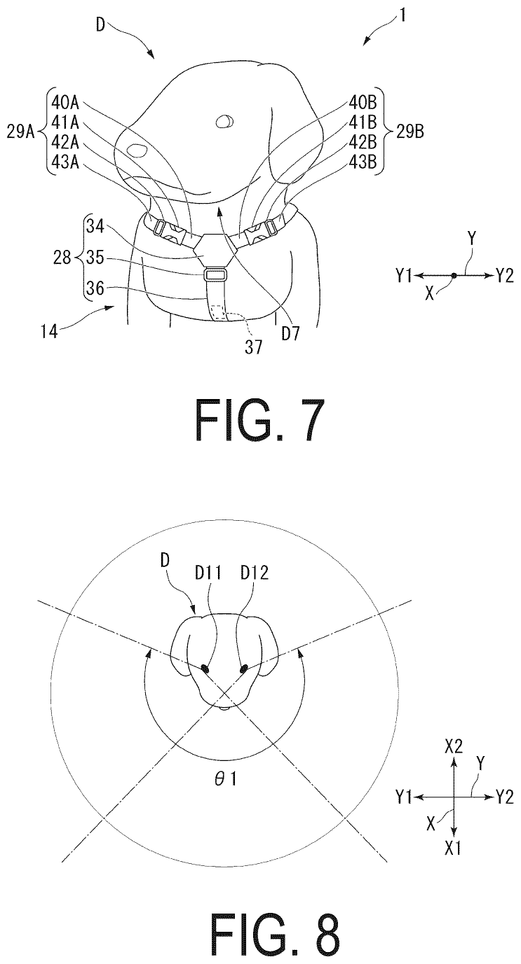

As shown in FIGS. 2 and 7, the coupler 28 includes, for example, a coupling member 34, a belt-feeding buckle 35 fixed to the coupling member 34, and a central belt 36 extending from the belt-feeding buckle 35 toward the rear side X2. The coupling member 34 is formed in a hexagonal plate shape by metal, resin, or the like. The belt-feeding buckle 35 is formed in a ring shape by metal, resin, or the like. The central belt 36 is held by the belt-feeding buckle 35. By changing a position of an end portion on the front side X1 of the central belt 36 held by the belt-feeding buckle 35, a position, in the front-rear direction X, of an end portion on the rear side X2 of the central belt 36 can be adjusted.

The end portion on the front side X1 of the central belt 36 can be attached to and detached from a longitudinal central portion of the central belt 36 by a hook-and-loop fastener 37. By attaching the end portion on the front side X1 of the central belt 36 by the hook-and-loop fastener 37, the end portion of the central belt 36 is less likely to interfere with movement of the dog D.

The first length adjustment mechanism 29A and the second length adjustment mechanism 29B are used by being attached around a neck portion D7 of the dog D.

As shown in FIG. 7, the first length adjustment mechanism 29A includes a first belt piece 40A extending from the coupling member 34 toward the right side Y1, an insertion buckle 41A fixed to an end portion of the first belt piece 40A, a belt-feeding buckle 42A fixed to the right side Y1 of the insertion buckle 41A, and a second belt piece 43A having a first end portion held by the belt-feeding buckle 42A.

The insertion buckle 41A has a known configuration and includes a protruding member and a recessed member (not shown), which are attachable to and detachable from each other. For example, the recessed member is fixed to the end portion of the first belt piece 40A, and the protruding member is fixed to the belt-feeding buckle 42A.

The first belt piece 40A and the second belt piece 43A can be connected or disconnected by attaching the protruding member and the recessed member to place the insertion buckle 41A in a connected state or separating the protruding member and the recessed member to place the insertion buckle 41A in a separated state.

A second end portion of the second belt piece 43A is sewn to the base material 16. By changing a position of a first end portion of the second belt piece 43A held by the belt-feeding buckle 42A, a length of the entire first length adjustment mechanism 28A can be adjusted.

The second length adjustment mechanism 29B is configured in the same manner as the first length adjustment mechanism 29A and includes a first belt piece 40B, an insertion buckle 41B, a belt-feeding buckle 42B, and a second belt piece 43B.

As shown in FIG. 1, a first end portion of the second belt piece 43B can be attached to and detached from the base material 16 by a hook-and-loop fastener 44B.

As shown in FIGS. 1 and 2, the first length adjustment mechanism 30A and the second length adjustment mechanism 30B are used by being attached around a portion on the front side X1 of a trunk D9 of the dog D.

The second length adjustment mechanism 30B is configured in the same manner as the first length adjustment mechanism 29A. The second length adjustment mechanism 30B includes a first belt piece 47B extending from an end portion on the rear side X2 of the central belt 36 toward the left side Y2, an insertion buckle 48B fixed to an end portion of the first belt piece 47B, a belt-feeding buckle 49B fixed to the insertion buckle 48B, and a second belt piece 50B having a first end portion held by the belt-feeding buckle 49B. A second end portion of the second belt piece 50B is sewn to the flap 16a of the base material 16. By changing a position of a first end portion of the second belt piece 50B held by the belt-feeding buckle 49B, a length of the entire second length adjustment mechanism 30B can be adjusted.

The first end portion of the second belt piece 50B can be attached to and detached from the base material 16 by a hook-and-loop fastener 51B.

Note that the attaching/detaching part 13 may include a third length adjustment mechanism 54 attached to the pair of flaps 16a and 16b of the base material 16.

When the base material 16 is formed of a relatively strong material, for example, the base material 16 and support plate 17 of the support member 11 may be integrally formed.

As shown in FIG. 5, the supplier 60 is provided on the attachment part 10. The supplier 60 supplies the feed into a field of view of the dog D in the standard posture. More specifically, the supplier 60 supplies the feed into the field of view of the dog D in the standard posture in a plan view.

The supplier 60 is disposed on the back portion D1 of the dog D in a state of being provided on the attachment part 10. That is, in this example, the supplier 60 is disposed outside the field of view of the dog D in the standard posture.

Here, the field of view in the left-right direction Y of the dog D in the standard posture will be described with reference to FIG. 8.

As shown in FIG. 8, for the dog D, a part of the field of view (viewing angle) by an eye D11 on the right side Y1 and a part of the field of view by an eye D12 on the left side Y2 overlap. For example, the field of view θ1 that can be visually recognized by one of the eyes D11 and D12 is 220° in the left-right direction Y with the front side X1 as the center.

For example, the field of view θ1 is 330° when the animal is a horse and 250° when the animal is a cat. Note that for example, the field of view θ1 of a human being is 200°.

The field of view may include not only the left-right direction Y but also the up-down direction of the animal.

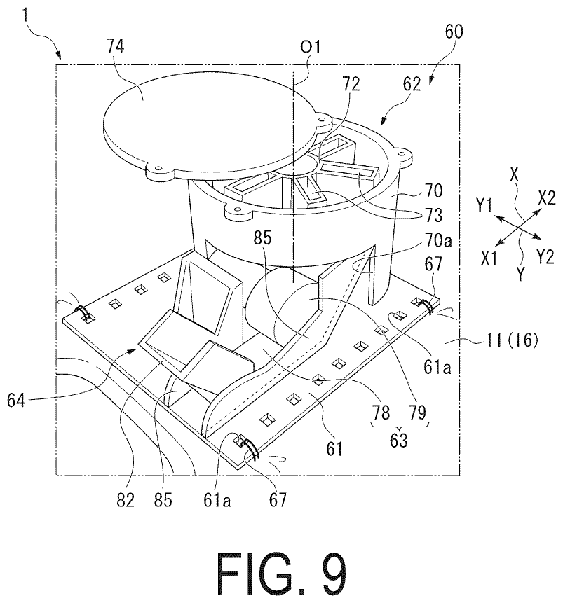

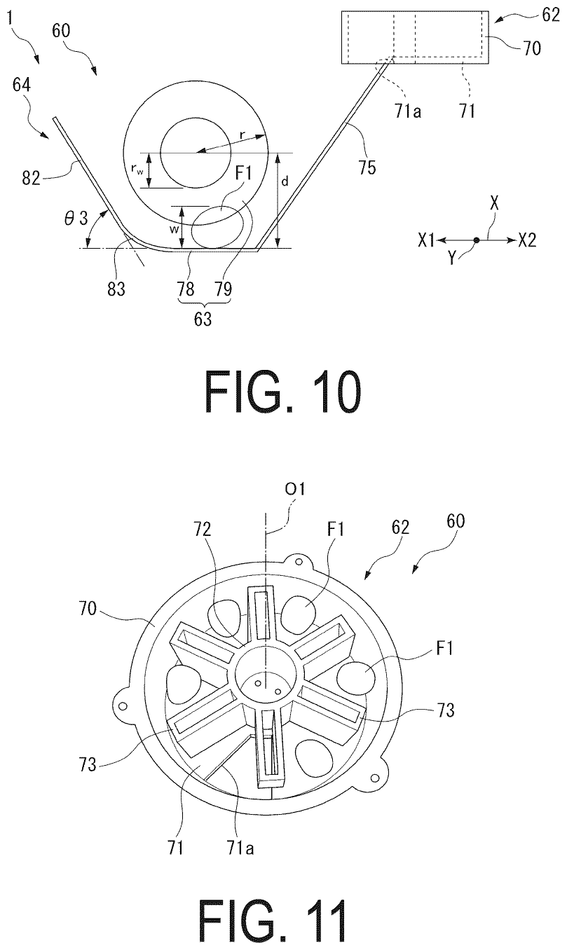

As shown in FIGS. 9 and 10, the supplier 60 includes a base plate 61, a holder 62, a launcher 63, and a trajectory corrector 64.

For example, the base plate 61 has a rectangular shape in a plan view. A plurality of through-holes 61a are formed in an outer edge portion of the base plate 61. The base plate 61 is disposed on the base material 16 of the support member 11. The base plate 61 is fixed to the base material 16 by a sewing thread 67 or the like having passed through the through-holes 61a.

The holder 62 holds a plurality of feeds and delivers the feeds based on control of controller 100. As shown in FIGS. 9 to 11, the holder 62 includes a side plate 70, a bottom plate 71, a shaft portion 72, a plurality of partition plates 73, a lid 74, a supply plate 75, and a first drive motor (not illustrated).

Here, the side plate 70 is formed in a cylindrical shape, the bottom plate 71 and the lid 74 are formed in a circular plate shape, and the shaft portion 72 is formed in a rod shape. A central axis (axial line) of each of the side plate 70, the bottom plate 71, the shaft portion 72, and the lid 74 is arranged coaxially with a common axis. Hereinafter, the common axis is referred to as an axial line O1. A direction along the axial line O1 (direction of the axial line O1) is an up-down direction.

When the feeding device 1 is seen from the direction of the axial line O1, a direction orthogonal to the axial line O1 is referred to as a radial direction, and a direction circling around the axial line O1 is referred to as a circumferential direction.

The side plate 70 is fixed to a portion on the rear side X2 of the base plate 61. A lower portion of the side plate 70 is formed with an opening 70a oriented in a direction between the front side X1 and the left side Y2.

As shown in FIG. 11, the bottom plate 71 has a circular plate shape. The bottom plate 71 is fixed to a portion above the opening 70a in the side plate 70. A drop hole 71a is formed in a part, in the circumferential direction, of the bottom plate 71. For example, a central angle of the drop hole 71a is 60°. A through-hole (not shown) is formed at the center of the bottom plate 71.

The shaft portion 72 passes through the through-hole of the bottom plate 71 and penetrates the bottom plate 71 in the up-down direction.

The plurality of (six in the present embodiment) partition plates 73 extend radially outward from a portion of the shaft portion 72 more protruding upward than the partition plates 73. The plurality of partition plates 73 are preferably disposed at equal angular intervals around the shaft portion 72.

Inside the side plate 70 and on the bottom plate 71, a feed F1 is accommodated between the partition plates 73 adjacent to each other in the circumferential direction. For example, the feed F1 is a granular dog food.

As shown in FIG. 9, the lid 74 covers an opening of an upper end portion of the side plate 70 in an openable and closable manner.

As shown in FIG. 10, a first end portion of the supply plate 75 is disposed below the drop hole 71a of the bottom plate 71. The supply plate 75 is gradually inclined downward toward the front side X1. The supply plate 75 conveys one feed F1 dropped through the drop hole 71a of the bottom plate 71 toward the front side X1. As shown in FIG. 9, the supply plate 75 protrudes toward the front side X1 of the side plate 70 through the opening 70a of the side plate 70. For example, the first drive motor is a servo motor. The first drive motor rotates the shaft portion 72 around the axial line O1.

The launcher 63 shoots the feed F1 delivered from the holder 62. As shown in FIGS. 9 and 10, the launcher 63 includes a support plate 78, a roller 79, and a second drive motor (not illustrated).

The support plate 78 extends from a lower end portion of the supply plate 75 toward the front side X1.

The roller 79 has a columnar or cylindrical shape. The roller 79 is disposed above the support plate 78. That is, a clearance through which the feed F1 passes is formed between the support plate 78 and the roller 79. An axial line of the roller 79 extends along the left-right direction Y.

The second drive motor rotates the roller 79 around the axial line of the roller 79. The second drive motor rotates the roller 79 so that a lower end portion of the roller 79 moves toward the front side X1.

The trajectory corrector 64 adjusts an orientation of the feed F1 to be shot so that the feed F1 shot from the launcher 63 is supplied into the field of view θ1 of the dog D in the standard posture. The trajectory corrector 64 includes a guide plate 82, an angle adjustment mechanism (not illustrated), and a coupling member 83.

The guide plate 82 is gradually inclined upward from the front side X1 of the support plate 78 toward the front side X1.

The angle adjustment mechanism is not limited as long as it is a mechanism capable of adjusting an angle θ3 (see FIG. 10) formed by the guide plate 82 with respect to the base plate 61. For example, the angle θ3 is a shooting angle of the feed F1 in the up-down direction.

For example, the angle adjustment mechanism includes a guide mechanism that rotatably guides the guide plate 82 around a front end portion of the support plate 78 and a holding mechanism that holds a position of the guide plate 82 that has been rotationally moved.

For example, a hinge is used as the guide mechanism. As the holding mechanism, a configuration in which a plate member provided on the guide plate 82 is sandwiched by a pair of sandwiching members provided on the base plate 61 can be used.

The angle adjustment mechanism may include a motor and may be configured so that the angle θ3 automatically changes.

As shown in FIG. 10, the coupling member 83 has an arc shape in a side view. The coupling member 83 is smoothly connected to each of a front end portion of the support plate 78 and a lower end portion of the guide plate 82.

In the present embodiment, a pair of guide plates 85 is provided so as to sandwich the supply plate 75, the support plate 78, and the guide plate 82 in the left-right direction Y. Each of the guide plates 85 protrudes upward from end portions, in the left-right direction Y, of the supply plate 75, the support plate 78, and the guide plate 82.

Note that the supplier 60 need not include the base plate 61.

Each element of the supplier 60 configured as described above is formed of synthetic resin, metal, or the like. The angle adjustment mechanism of the supplier 60 can adjust the shooting angle, in the up-down direction, of the feed F1 by adjusting the angle θ3.

Note that the angle adjustment mechanism of the supplier 60 may be further capable of adjusting the shooting angle, in the left-right direction Y, of the feed F1.

The sound generator 90 includes a speaker. The sound generator 90 generates a sound when the supplier 60 supplies the feed F1. The sound generator 90 may generate a clicker sound, a voice for a person to praise a dog, or the like.

The first wireless communicator 95 includes an antenna, an amplifier circuit, and the like, which are not shown. A known wireless LAN, Bluetooth (registered trademark), or the like is used for wireless communication. The first wireless communicator 95 receives a signal by wireless communication and transmits the received signal to the controller 100.

For example, the controller 100 includes a central processing unit (CPU) and a memory, which are not shown. The controller 100 is connected to each of the drive motor of the supplier 60, the sound generator 90, and the first wireless communicator 95. The controller 100 controls the drive motor of the supplier 60 and the sound generator 90.

The power supply unit 105 supplies electric power to each of the drive motor of the supplier 60, the sound generator 90, the first wireless communicator 95, and the controller 100.

A mass of the feeding device 1 configured as described above is preferably 10% or less of a weight (mass) of the dog D.

Note that the feeding device 1 is remotely operated by an operation device (not shown).

For example, the operation device includes an operator and a second wireless communicator. The operator is a joystick or the like. A user gives an instruction to the operation device by tilting the operator, or the like.

The second wireless communicator transmits a signal to the first wireless communicator 95 of the feeding device 1 by wireless communication based on the instruction given to the operator.

Next, an operation of the feeding device 1 configured as described above will be described.

The angle θ3 of the guide plate 82 is adjusted in advance by the angle adjustment mechanism of the supplier 60 in accordance with the dog D to which the feeding device 1 is attached.

First, the user attaches the feeding device 1 to the dog D. Specifically, the insertion buckles 41A, 41B, 48A, and 48B of the attaching/detaching part 13 are appropriately placed into a separated state, or the length adjustment mechanisms 28A, 28B, 29A, and 29B are lengthened.

The user passes the neck portion D7 of the dog D between the base material 16 and the length adjustment mechanisms 28A and 28B. The insertion buckles 41A, 41B are placed into a connected state as required. The first end portions of the second belt pieces 43A and 43B are grasped by the left and right hands and pulled away and spaced from the coupling member 34 of the coupler 28. The lengths of the length adjustment mechanisms 28A and 28B are equally shortened on the left and right sides, and the length adjustment mechanisms 28A and 28B are attached to the neck portion D7.

Each front leg D14 (see FIG. 1) is passed between the length adjustment mechanisms 29A and 29B and the central belt 36.

The pair of sponges 12 are disposed so as to come into contact with the back portion D1 of the dog D. At this time, as shown in FIG. 4, the sponges 12 are arranged so as to extend in the front-rear direction X and sandwich the backbone D3 of the dog D between the pair of sponges 12. Further, in each sponge 12, the first elastic piece 24 is arranged closer to the head portion D5 side of the dog D than the second elastic piece 25. The sponges 12 extending in the front-rear direction X are attached along the backbone D3 of the dog D.

The insertion buckles 48A and 48B are placed into the connected state as required. The first end portions of the second belt pieces 50A and 50B are grasped by the left and right hands and pulled away and spaced from the central belt 36 of the coupler 28. The lengths of the length adjustment mechanisms 30A and 30B are equally shortened on the left and right sides, and the length adjustment mechanisms 30A and 30B are attached to the portion on the front side X1 of the trunk D9.

By the above procedure, the feeding device 1 is attached to the back portion D1 of the dog D by the attaching/detaching part 13.

When the feeding device 1 is attached to the back portion D1 of the dog D, the pair of sponges 12 are compressed in the thickness direction. It is preferable that the left and right weights of the feeding device 1 are substantially equal, and it is preferable that the center of gravity of the feeding device 1 is lower.

When the feeding device 1 is activated, the power supply unit 105 of the feeding device 1 supplies electric power to the drive motor and the like of the supplier 60. The dog D to which the feeding device 1 is attached conducts an action such as work training and exercise as a service dog or a general household dog.

When a certain period of time has elapsed since the dog D started to move, the user operates the operation device in order to provide the feed F1 to the dog D. Specifically, the user operates the operator of the operation device. Thus, the second wireless communicator of the operation device emits a signal, and the first wireless communicator 95 of the feeding device 1 receives the signal. The signal received by first wireless communicator 95 is transmitted to the controller 100 of the feeding device 1.

When this signal is received, the controller 100 may cause the sound generator 90 to generate a sound. Then, the controller 100 causes the supplier 60 to supply the feed F1. That is, upon receiving the signal from the operation device, the controller 100 generates a sound or supplies the feed F1.

Specifically, the controller 100 causes the second drive motor of the supplier 60 to rotate the roller 79. The controller 100 causes the first drive motor of the supplier 60 to rotate the shaft portion 72 around the axial line O1 by a predetermined angle. Thus, one feed F1 held in the holder 62 of the supplier 60 is dropped downward through the drop hole 71a of the bottom plate 71. This feed F1 is guided by the supply plate 75 and delivered onto the support plate 78 of the launcher 63.

The feed F1 delivered onto the support plate 78 is shot toward the front side X1 by the rotating roller 79. The feed F1 is guided by the coupling member 83 and the guide plate 82 of the trajectory corrector 64 and is obliquely shot from the supplier 60 toward the front side X1. Due to the pair of guide plates 85, the feed F1 is less likely to fall from the supply plate 75, the support plate 78, and the guide plate 82 of the supplier 60.

The trajectory corrector 64 is designed at an angle at which the feed F1 does not hit the head portion of the dog D regardless of the posture of the dog D. Therefore, the shot feed F1 is shot into a visible range of the dog D in the form of passing over the head portion of the dog D.

A trajectory of the feed F1 shot from the supplier 60 is indicated by a two-dot chain line L0 in FIG. 1.

The controller 100 causes the sound generator 90 to generate a sound.

Note that a flying distance of the feed F1 can be adjusted by adjusting the rotation speed of the roller 79 driven by the second drive motor.

At this time, when the dog D is in the standard posture, the dog D visually recognizes the feed F1 shot from the feeding device 1 and eats the feed F1. On the other hand, even when the dog D is not in the standard posture and does not visually recognize the feed F1, the dog D listening to the sound generated by the sound generator 90 looks around. Then, the dog D visually recognizes the feed F1 and eats the feed F1.

As described above, in the feeding device 1 of the present embodiment, the feeding device 1 is attached to the back portion D1 of the dog D by the attachment part 10, whereby the feeding device 1 moves to a movement destination of the dog D integrally with the dog D. Based on the control of the controller 100, the supplier 60 provided on the attachment part 10 supplies the feed F1. When the dog D is in the standard posture, since the feed F1 is supplied into the field of view θ1 of the dog D, the dog D visually recognizes the feed F1. Note that when a color of the feed F1 is white rather than black, it is easier for the dog D to visually recognize the feed.

Therefore, it is possible to supply the feed F1 to a position easily noticeable by the dog D at the movement destination of the dog D.

The supplier 60 is disposed on the back portion D1 of the dog D. According to the study of the present inventors, when the dog D or the like is supplied with the feed F1 from the collar or the chest strap many times, the dog D or the like stays at a position where the feed F1 is supplied and does not move forward or does not concentrate on training or the like. On the other hand, when the supplier 60 is disposed on the back portion D1, the feed F1 can be supplied without being noticed by the dog D, making it possible to guide the dog D in a desired direction. Therefore, by disposing the supplier 60 outside the field of view θ1 of the dog D in the standard posture, it is possible to suppress the dog D from being distracted by the supplier 60 and prevent any hindrance to the motion of the dog D. Note that the back portion D1 of the animal means the back portion outside the field of view θ1 of the animal.

The supplier 60 includes the holder 62, the launcher 63, and the trajectory corrector 64. Accordingly, the holder 62 delivers the held feed F1 to the launcher 63 based on the control of controller 100. Then, the launcher 63 shoots the feed F1, and the trajectory corrector 64 can adjust the orientation of the feed F1 to be shot so that the shot feed F1 is supplied into the field of view θ1 of the dog D in the standard posture.

Since the launcher 63 includes the roller 79, the sound generated when the feed F1 is shot is relatively small. Therefore, it is possible to reduce the influence on the dog D when shooting the feed F1.

The sponge 12 includes the thin first elastic piece 24 on the front side X1 and the thick second elastic piece 25 on the rear side X2. Therefore, as shown in FIG. 5, the supplier 60 is attached to the back portion X1 of the dog D in a state where the supplier 60 is gradually inclined downward toward the front side D1. The feed F1 held by the holder 62 is conveyed to the front side X1 over the supply plate 75, and can be more reliably supplied to the launcher 63. The feeding device 1 includes the sound generator 90. Thereby, the dog D can be made aware of the feed F1 by the sound generated by the sound generator 90 that the supplier 60 is supplying the feed F1.

The feeding device 1 includes the first wireless communicator 95. For example, when the first wireless communicator 95 receives a signal transmitted from the second wireless communicator of the operation device, the first wireless communicator 95 transmits the signal to the controller 100. When the signal is received, the controller 100 causes the supplier 60 to supply the feed F1. Therefore, the user can supply the feed F1 to the dog D by issuing an instruction to the controller 100 from a distance from the feeding device 1.

The configuration of the feeding device 1 according to the first embodiment of the present invention can be variously modified as described below.

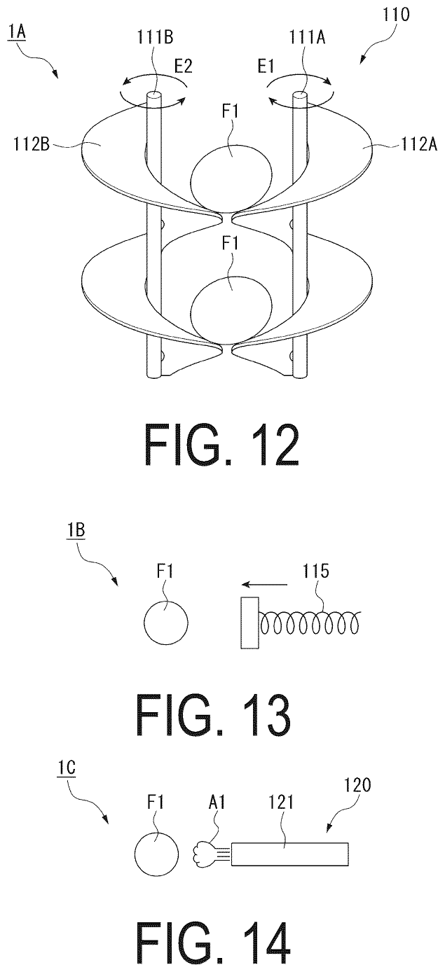

As in a feeding device 1A according to a first modification illustrated in FIG. 12, a holder 110 of the supplier may include a pair of rotation shafts 111A and 111B, spiral members 112A and 112B, and a first drive motor (not illustrated).

The rotation shafts 111A and 111B are disposed side by side so as to be parallel to each other.

The spiral members 112A and 112B are wound in opposite directions to each other. That is, for example, if the spiral member 112A is right-handed, the spiral member 112B is left-handed.

The spiral member 112A is wound around the rotation shaft 111A. The spiral member 112B is wound around the rotation shaft 111B.

The first drive motor rotates the rotation shaft 111A in a direction E1 around the rotation shaft 111A. The first drive motor rotates the rotation shaft 111B in a direction E2 opposite to the direction E1 around the rotation shaft 111B.

The feed F1 is disposed between portions of the spiral members 112A and 112B which make one turn around the rotation shafts 111A and 111B.

The holder 110 of the feeding device 1A according to the first modification configured as described above can also hold the feed F1 and deliver the feed F1 based on the control of the controller 100.

As in a feeding device 1B according to a second modification shown in FIG. 13, a launcher 115 of the supplier may be configured by a spring. The launcher 115 shoots the feed F1 supplied from the holder 62 by the elastic force of the launcher 115. Note that the launcher may have a solenoid.

As in a feeding device 1C according to a third modification shown in FIG. 14, a launcher 120 of the supplier may include a tubular body 121 and an air supplier (not shown).

The air supplier supplies compressed air A1 from a first end portion of the tubular body 121 into the tubular body 121. The feed F1 is disposed at a second end portion of the tubular body 121 opposite the first end portion. The feed F1 is shot by the air A1 blowing from the second end portion of the tubular body 121.

In this manner, the launcher 120 shoots the feed F1 supplied from the holder 62 by the air A1.

As in a feeding device 1D according to a fourth modification shown in FIG. 13, a launcher 125 of the supplier may include a rod-shaped member 126, an accommodation portion 127, and a first drive motor (not illustrated).

For example, the accommodation portion 127 has a dome shape. The accommodation portion 127 is fixed to a first end portion of the rod-shaped member 126. The feed F1 is accommodated in the accommodation portion 127.

The first drive motor rotates the rod-shaped member 126 around a second end portion opposite to the first end portion.

The launcher 125 shoots the feed F1 supplied from the holder 62 by a method such as throwing.

Although the first embodiment of the present invention has been described above in detail with reference to the drawings, the specific configuration is not limited to the present embodiment, and changes, combinations, deletions, and the like of configurations within the scope not departing from the gist of the present invention are also included. The same applies to a second embodiment described below.

For example, in the embodiment described above, the supplier may be attached to the shoulder portions of the dog D indicated by the two-dot chain line M1 in FIG. 1 as long as the supplier is disposed outside the field of view θ1 of the dog D. The orientation in which the feed F1 is shot from the supplier may be an orientation between the front side X1 and the right side Y1, an orientation between the front side X1 and the left side Y2, or the like, instead of the front side X1.

The feeding device 1 need not include the sound generator 90, the first wireless communicator 95, and the power supply unit 105. The feeding device 1 may be used for exercise (an opportunity of exercise) of the dog D.

In addition, an imaging means such as a camera capable of observing a surrounding situation may be provided at a predetermined portion such as the attachment part 10 of the feeding device 1. The first wireless communicator 95 or the like transfers an image captured by the imaging means to the user who instructs the training or the owner, so that the user or owner can perform the operation of changing the shooting direction of the feed F1 in accordance with the training, the situation of the dog D, and the direction in which the dog D is to be moved while remotely seeing the situation of the dog D and the surrounding situation, thereby reliably supplying the feed.

In the embodiment, the animal to which the feeding device is attached is not limited to a dog, but is preferably a vertebrate. Examples of the vertebrate include a horse, a donkey, a monkey, and the like. The animal need not be a vertebrate.

### Test Results

Hereinafter, test results for determining specifications of the feeding device 1 will be described.

As the feed F1, Nutro (registered trademark) shown in FIG. 16 was used. The feed F1 has a columnar shape. The reason why Nutro was selected is that it has a small variation in shape, is hard and strong, and is easy to handle in the feeding device 1.

The diameter (L1), thickness (L2), and diagonal length (L3) of the feed F1 are shown in FIG. 16. The measurement results of the diameters L1, thicknesses L2, and diagonal lengths L3 of 20 randomly selected feeds F1 are shown in Table 1.

TABLE 1

| | Maximum | Minimum | | Standard |
|---|---|---|---|---|
| [mm] | value | value | Average | deviation |
| Diameter (L1) | 13.18 | 11.32 | 12.20 | 0.561 |
| Thickness (L2) | 9.60 | 7.52 | 8.63 | 0.541 |
| Diagonal length (L3) | 13.56 | 11.62 | 12.47 | 0.657 |

For example, the maximum value of the diameter L1 is 13.18 mm. For the diameter L1, the minimum value is 11.32 mm, the average is 12.20 mm, and the standard deviation is 0.561 mm.

In the feeding device 1 shown in FIG. 10, the roller 79 had a cylindrical shape. The inside diameter r_{w} of the roller 79 was 8.8 mm.

As the roller 79, the following three types of rollers were used for the test.

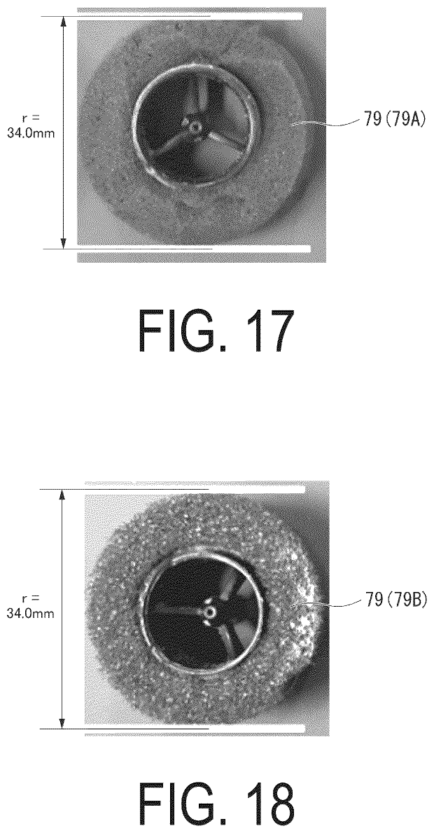

The roller 79 shown in FIG. 17 is a roller 79A made of sponge 1, which is a first type of sponge. Of the two types of sponges used in the test, the first type of sponge is relatively hard and coarse. The outer diameter r of the roller 79A is 34.0 mm.

The roller 79 shown in FIG. 18 is a roller 79B made of sponge 2, which is a second type of sponge. Of the two types of sponges used in the test, the second type of sponge is relatively soft and fine. The outer diameter r of the roller 79B is 34.0 mm.

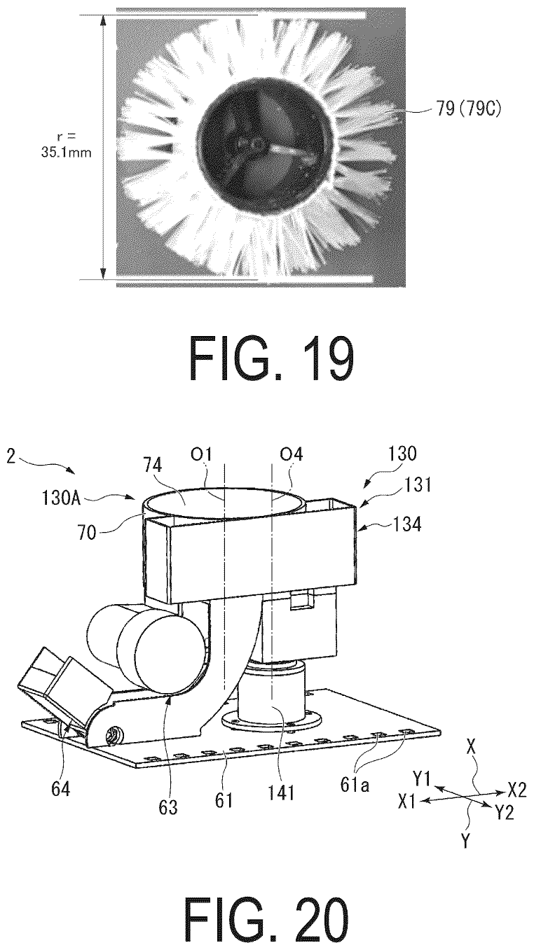

The roller 79 shown in FIG. 19 is a roller 79C made of nylon. The outer diameter r of the roller 79C is 35.1 mm.

As shown in FIG. 10, the distance from the center of the roller 79 to the support plate 78 is defined as d. The size of the feed F1 is defined as w. At this time, a distance d for preventing the feed F1 from being clogged is expressed by Equation (1).

$$d > w + {r}_{w} . \qquad ( 1 )$$

The angle θ3 was set to 50° and the distance d was set to 23.0, 23.5, 24.0, and 24.5 mm. The feed F1 was shot five times each by the rollers 79A to 79C. The average and standard deviation of the measured flying distances of the feed F1 are shown in Table 2.

TABLE 2

| | |
|---|---|
| D = 23.0 [mm] | D = 23.5 [mm] |

| | | Standard | | Standard |
|---|---|---|---|---|
| [cm] | Average | deviation | Average | deviation |
| Sponge 1 | 325 | 22 | 327 | 32 |
| Sponge 2 | 408 | 78 | 403 | 73 |
| Nylon | 247 | 40 | 223 | 40 |

| | |
|---|---|
| D = 24.0 [mm] | D = 24.5 [mm] |

| | | Standard | | Standard |
|---|---|---|---|---|
| [cm] | Average | deviation | Average | deviation |
| Sponge 1 | 317 | 27 | 319 | 30 |
| Sponge 2 | 452 | 96 | 460 | 89 |
| Nylon | 204 | 66 | 165 | 77 |

For example, when the distance d was 23.0 mm and the roller 79A made of sponge 1 was used, the average of the flying distances of the feed F1 was 325 cm and the standard deviation was 22 cm.

Since the flying distance of the feed F1 was long, the standard deviation of the flying distance was small, and the flying distance was stable, the roller 79A made of sponge 1 was employed, and the distance d was set to 23.5 mm.

### Second Embodiment

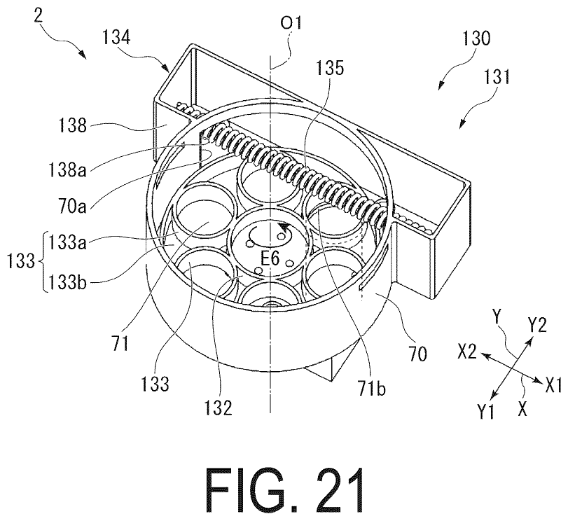

Next, a second embodiment of the present invention will be described with reference to FIGS. 20 and 21, in which the same portions as those of the above-described embodiment are denoted by the same reference numerals and description thereof will be omitted, and only different points will be described. The second embodiment is characterized in that a holder 131 is configured to deliver more feeds F1 one by one, and an orientation adjustor 141 is configured to adjust the shooting direction of the feed F1.

As shown in FIGS. 20 and 21, a feeding device 2 of the present embodiment includes a supplier 130 that holds a plurality of feeds F1, instead of the supplier 60 in each configuration of the feeding device 1.

The supplier 130 includes a holder 131 and an orientation adjustor 141, instead of the holder 62 in each configuration of the supplier 60.

The holder 131 includes a shaft portion 132, a dish-shaped member 133 having a plurality of holding pieces 133a, a side case 134, and a spring 135, instead of the shaft portion 72 and the plurality of partition plates 73 in each configuration of the holder 62.

As shown in FIG. 21, in this example, a drop hole 71b is formed in the bottom plate 71, instead of the drop hole 71a. The drop hole 71b has a circular shape close to the shape of the feed F1 when seen from the direction of the axial line O1 and is formed in a part of the bottom plate 71 in the circumferential direction. For example, the drop hole 71b is formed in a portion on the left side Y2 of the bottom plate 71.

One feed F1 (not illustrated) can pass through the drop hole 71b. The feed F1 passing through the drop hole 71b is supplied to the launcher 63.

A cutout 70a is formed in a part, in the circumferential direction and in the up-down direction, of the side plate 70. The cutout 70a is formed in a portion on the left side Y2 of the side plate 70 so as to be disposed within a range including the drop hole 71b in the circumferential direction.

The shaft portion 132 is formed in a rod shape and disposed on the axial line O1.

Each holding piece 133a is formed in a cylindrical shape in the dish-shaped member 133 disposed on the bottom plate 71. Inner portions of the plurality of holding pieces 133a are bottomless (penetrate in the direction of the axial line O1). For example, an inner diameter of the holding piece 133a is 15.5 mm. The plurality of holding pieces 133a are included in the dish-shaped member 133 and are connected to each other by a connecting plate 133b disposed on the bottom plate 71.

The dish-shaped member 133 including the plurality of holding pieces 133a is disposed on the bottom plate 71. The plurality of holding pieces 133a are disposed radially outward of the shaft portion 132. Although the shape of the holding piece 133a is shown as a circle in FIG. 21, the shape is not limited thereto and may be an appropriate shape such as a square in accordance with the shape of the feed F1. The plurality of holding pieces 133a are disposed around the shaft portion 132, that is, inside an outer peripheral circle of the dish-shaped member 133. The plurality of holding pieces 133a are fixed to the shaft portion 132. The plurality of holding pieces 133a have a so-called revolver structure.

The plurality of holding pieces 133a rotate around the axial line O1 integrally with the shaft portion 132. In this example, the plurality of holding pieces 133a rotate in a direction E6 (counterclockwise in a plan view) around the axial line O1.

One feed F1 is accommodated in each holding piece 133a on the bottom plate 71. When the holding piece 133a is disposed on the drop hole 71b of the bottom plate 71, the feed F1 in the holding piece 133a passes through the drop hole 133a of the bottom plate 71 and is supplied to the launcher 63 because the inner portion of the holding piece 71b is bottomless.

For example, the side case 134 is formed in a box shape with an open top. The side case 134 extends in the front-rear direction X.

A cutout 138a is formed in a portion of a sidewall 138 of the side case 134 corresponding to the cutout 70a of the side plate 70.

The sidewall 138 of the side case 134 is connected to the side plate 70. The cutout 70a of the side plate 70 is disposed in the side case 134.

Locking portions (not illustrated) such as hooks are respectively fixed to both end portions of the side case 134 in the front-rear direction X.

For example, the spring 135 is a helical spring. The spring 135 is disposed in the side case 134 and extends in the front-rear direction X through the cutout 70a of the side plate 70. Both end portions of the spring 135 in the front-rear direction X are respectively locked with the locking portions of the side case 134.

The spring 135 extends over the drop hole 71b of the bottom plate 71. A distance between the spring 135 and the holding piece 133a is preferably shorter than the diameter and thickness of the feed F1 so that a plurality of feeds F1 do not enter between the spring 135 and the holding piece 133a.

The orientation adjustor 141 incorporates a servo motor that can be driven by remote operation such as wireless control. For example, as shown in FIG. 20, the orientation adjustor 141 is disposed on the base plate 61 and fixed to the bottom plate 71 of the holder 131. The orientation adjustor 141 rotates the holder 131, the launcher 63, and the trajectory corrector 64 (hereinafter, referred to as a partial supplier 130A), which are integrated with each other, around an axial line O4 parallel to the axial line O1.

When the partial supplier 130A rotates around the axial line O4, an orientation, in the yaw direction, of the feed F1 shot out from the dog D is adjusted.

Next, the operation of the feeding device 2 configured as described above will be described, focusing on the holder 131.

For example, a plurality of (for example, about 20) feeds F1 are accommodated in the holder 131. Some of the plurality of feeds F1 are accommodated within the plurality of holding pieces 133a. The remainder of the plurality of feeds F1 is accommodated above the plurality of holding pieces 133a and below the lid 74.

When the first drive motor is driven, the shaft portion 132 and the plurality of holding pieces 133a integrally rotate in the direction E6. When one feed F1 accommodated in the holding piece 133a moves above the drop hole 71b of the bottom plate 71, the feed F1 drops through the drop hole 71b. Then, it is supplied to the launcher 63 and shot, and the orientation thereof is adjusted by the trajectory corrector 64.

At this time, the spring 135 is disposed above the holding piece 133a on the drop hole 71b. Therefore, it is possible to prevent a plurality of feeds F1 from being supplied to the launcher 63 through the drop hole 71b at a time.

When the holding piece 133a from which the feed F1 has dropped moves in the circumferential direction from below the spring 135, the feed F1 on the holding piece 133a drops into the holding piece 133a and is accommodated therein.

The feeding device 2 of the present embodiment configured as described above can achieve the same effects as those of the feeding device 1 of the first embodiment.

Further, since the feeding device 2 includes the holder 131, it is possible to accommodate more feeds F1.

In addition, the feeding device 2 includes the orientation adjustor 141. For example, a case will be described as an example in which it is visually recognized from the image of the imaging means that there is an obstacle into which the feed F1 is likely to enter on the right side Y1 of the feeding device 2 attached to the dog D. In this case, even if the feed F1 is shot toward the right side Y1 of the feeding device 2, the feed F1 enters the obstacle, making it difficult for the dog D to eat the feed F1. In this case, by adjusting the orientation in which the feed F1 is shot to the left side Y2 via remote operation by the orientation adjustor 141, it becomes easier for the dog D to eat the shot feed F1, ensuring that the feed F1 is reliably supplied to the dog D.

### Industrial Applicability

According to the present invention, it is possible to provide a feeding device capable of guiding an animal in an expected direction while supplying the feed to a position easily noticeable by the animal at a movement destination of the animal. Therefore, the industrial applicability is significant.

### REFERENCE SIGNS LIST

1, 1A, 1B, 1C, 1D, 2 Feeding device
10 Attachment part
11 Support member
12 Sponge (elastic member)
13 Attaching/detaching part
24 First elastic piece
25 Second elastic piece
60, 130 Supplier
62, 110, 131 Holder
63, 115, 120, 125 Launcher
64 Trajectory corrector
90 Sound generator
95 First wireless communicator (wireless communicator)
100 Controller
D dog (vertebrate, animal)
D1 Back portion
D3 Backbone
D5 Head portion
F1 Feed
X1 Front side
θ1 Field of view

1. A feeding device, comprising:
an attachment part configured to be attached to an animal;
a supplier provided on the attachment part and configured to supply a feed into a field of view of the animal that is in a standing posture and faces forward; and
a controller configured to control the supplier, wherein:
the supplier is disposed on a back portion of the animal in a state of being provided on the attachment part.

2. The feeding device according to claim 1, wherein the supplier includes:
a holder configured to hold the feed and deliver the feed based on control of the controller,
a launcher configured to shoot the feed supplied from the holder, and
a trajectory corrector configured to adjust an orientation of the feed to be shot so that the feed shot from the launcher is supplied into the field of view of the animal that is in a standing posture and faces forward.

3. The feeding device according to claim 1, wherein;
the animal is a vertebrate,
the attachment part includes:
a support member disposed on a back portion of the vertebrate,
a pair of elastic members attached to an outer surface of the support member on the back portion side and being in contact with the back portion with a backbone of the vertebrate interposed therebetween, and
an attaching/detaching part configured to detachably attach the support member to the back portion of the vertebrate, and
each of the elastic members includes:
a first elastic piece disposed on a head portion side of the vertebrate, and
a second elastic piece disposed on a side opposite to the head portion with respect to the first elastic piece and thicker than the first elastic piece.

4. The feeding device according to claim 1, further comprising:
a sound generator configured to generate a sound when the feed is supplied by the supplier.

5. The feeding device according to claim 1, further comprising:
a wireless communicator configured to receive a signal by wireless communication and transmit the received signal to the controller, wherein;
the controller supplies the feed by the supplier when the signal is received.
